(19) United States
(12) Patent Application Publication
(10) Pub. No.: US 2011/0131427 A1
(43) Pub. Date: Jun. 2, 2011

(54) POWER MANAGEMENT STATES

(76) Inventors: Joel A. Jorgenson, Fargo, ND (US); Bradley R. Thurow, Fargo, ND (US); Michael J. Schmitz, Golden Valley, MN (US); Andrew J. Paulsen, Fargo, ND (US)

(21) Appl. No.: 12/956,882

(22) Filed: Nov. 30, 2010

Related U.S. Application Data
(60) Provisional application No. 61/266,079, filed on Dec. 2, 2009.

(51) Int. Cl. G06F 1/26

(52) U.S. Cl. 713/300

(57) ABSTRACT

Utilizing software-based power management states to determine changes in a processing demand and provide changes in energy to be delivered to an electronic system.

### REFERENCE TO RELATED APPLICATION

This application claims the benefit of U.S. Provisional Patent Application No. 61/266,079, filed on Dec. 2, 2009, the contents of which are incorporated by reference.

### TECHNICAL FIELD

The present invention relates generally to power management and in particular to managing power in response to decoding software-based power management states of an electronic system.

### BACKGROUND

As digital electronic processing systems trend toward higher operating frequencies and smaller device geometries, power management has become increasingly important to prevent thermal overload while maintaining system performance and prolonging battery life in portable systems.

### BRIEF DESCRIPTION OF THE DRAWINGS

The present invention is illustrated by way of example and not limitation in the figures of the accompanying drawings, in which:

FIG. 1 is a block diagram illustrating one embodiment of an on-demand power management system utilizing software-based power management states of an electronic system to detect changes in a processing demand and generate changes in energy to be delivered to the electronic system.

FIG. 2 is a diagram illustrating exemplary software-based power management states of the electronic system as defined in the Advanced Configuration and Power Interface (ACPI) specification according to one embodiment.

FIG. 3 are timing diagrams illustrating exemplary transitions of processor power states (C states) and corresponding exemplary changes to the energy delivered to the electronic system in response to the processor state transitions.

FIG. 4 are timing diagrams illustrating exemplary transitions of sleeping states (S states) and corresponding exemplary changes to the energy delivered to the electronic systems in response to the sleeping state transitions.

FIG. 5 is a block diagram illustrating one embodiment of a power manager, including a state decoder.

FIG. 6 is a block diagram illustrating one embodiment of the state decoder implemented in connection with a state machine of a power management controller.

FIG. 7 is a block diagram illustrating one embodiment of the state decoder implemented in connection with a power management algorithm stored in programmable memory.

FIG. 8 is a flow diagram illustrating one embodiment of a lower envelope algorithm (LEA).

FIG. 9 is a block diagram illustrating one embodiment of the power management controller (PMC) having a state decoder with combinational logic to decode software-based power management states of a processor of the electronic system.

FIG. 10 is a block diagram illustrating another embodiment of the power management controller (PMC) having a state decoder coupled to receive a signal indicative of peripheral energy consumption of a peripheral device of the electronic system.

FIG. 11 illustrates a diagrammatic representation of a machine in the exemplary form of a computing system for software-based power management state decoding.

FIG. 12 illustrates a generalized PMA having multiple operating states directly mapped to software-based power management states according to one embodiment.

### DETAILED DESCRIPTION

In the following description, numerous specific details are set forth such as examples of specific components, devices, methods, etc., in order to provide a thorough understanding of embodiments of the present invention. It will be apparent, however, to one skilled in the art that these specific details need not be employed to practice embodiments of the present invention. In other instances, well-known materials or methods have not been described in detail in order to avoid unnecessarily obscuring embodiments of the present invention. It should be noted that the “line” or “lines” discussed herein, that connect elements, may be single lines or multiple lines. It will also be understood by one having ordinary skill in the art that lines and/or other coupling elements may be identified by the nature of the signals they carry (e.g., a “clock line” may implicitly carry a “clock signal”) and that input and output ports may be identified by the nature of the signals they receive or transmit (e.g., “clock input” may implicitly receive a “clock signal”). Reference in the description to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

The two principal sources of power dissipation in digital logic circuits are static power dissipation and dynamic power dissipation. Static power dissipation is dependent on temperature, device technology, and processing variables, and is composed primarily of leakage currents. Dynamic power dissipation is the predominant loss factor in digital circuitry and is proportional to the operating clock frequency, the square of the operating voltage and the capacitive load. Capacitive load is highly dependent on device technology and processing variables, so most approaches to dynamic power management focus on frequency and voltage control.

In some data processing systems, processors within the systems execute software at the operating system (OS) level to perform power management for the processor itself. The processor core of a typical data processing system may use software-based power management states defined by standards. For example, the software-based power management standard may be the Advanced Configuration and Power Interface (ACPI) specification. The ACPI specification is an open standard for unified operating systems-centric device configuration and power management. ACPI, first released in December 1996, defines platform-independent interfaces for hardware discovery, configuration, power management, and monitoring. The specification is central to Operating System-directed configuration and Power Management (OSPM); a term used to describe a system implementing ACPI, which therefore removes device management responsibilities from legacy firmware interfaces. Intel, Microsoft, and Toshiba originally developed the standard. Current developers of the standard also include HP and Phoenix and the specification was last published as “Revision 4.0a,” on Apr. 5, 2010.

The ACPI specification contains numerous related components, for hardware and software programming, as well as a unified standard for device power interaction and bus configuration. As a document that unifies many previous standards, it covers many areas, for system and device builders as well as system programmers. Some software developers have trouble implementing ACPI and express concerns about the requirements that bytecode from an external source must be run by the system with full privileges.

It should be noted that although various embodiments may be described hereinafter in regards to the ACPI specification, in alternative embodiments, other software based standard protocols may be used.

In one embodiment, the state information that is developed as part of the ACPI specification may be used by a power management system that provides a hardware-based system-wide power management solution. The specific Performance states (P0-Pn), Device states (D0-D3), Processor states (C0-C3), and sleeping states (S0-S5) may be used as part of the detection mechanism of an On-Demand Power, power management controller that detects changes in the application demand and generates changes in system signals to provide just-in-time, just-enough energy delivery. The ACPI states are defined and managed by the operating system, and is largely concentrated on the dynamic power management within a central processing unit (CPU). Nevertheless, the same ACPI states, if brought externally from the CPU, may be detected by a power management controller (PMC) to dynamically adjust the energy to be delivered (e.g., supply voltages and clock frequencies) to the electronic system without interrupting the system. Such is a point-of-source approach to dynamic power management. The electronic system may be, for example but not limited to, a portable electronic system, such as a radio, a phone, a camera, a sensor, etc., laptop computer, or a non-portable electronic system, such as a desktop computer, a server, etc.

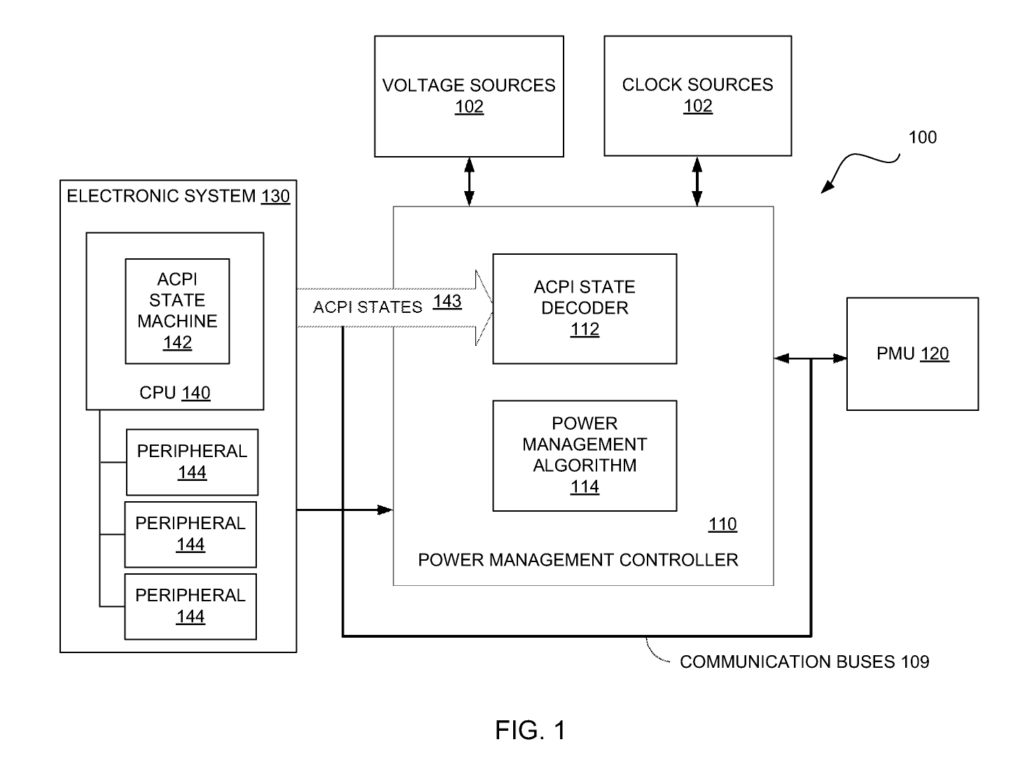

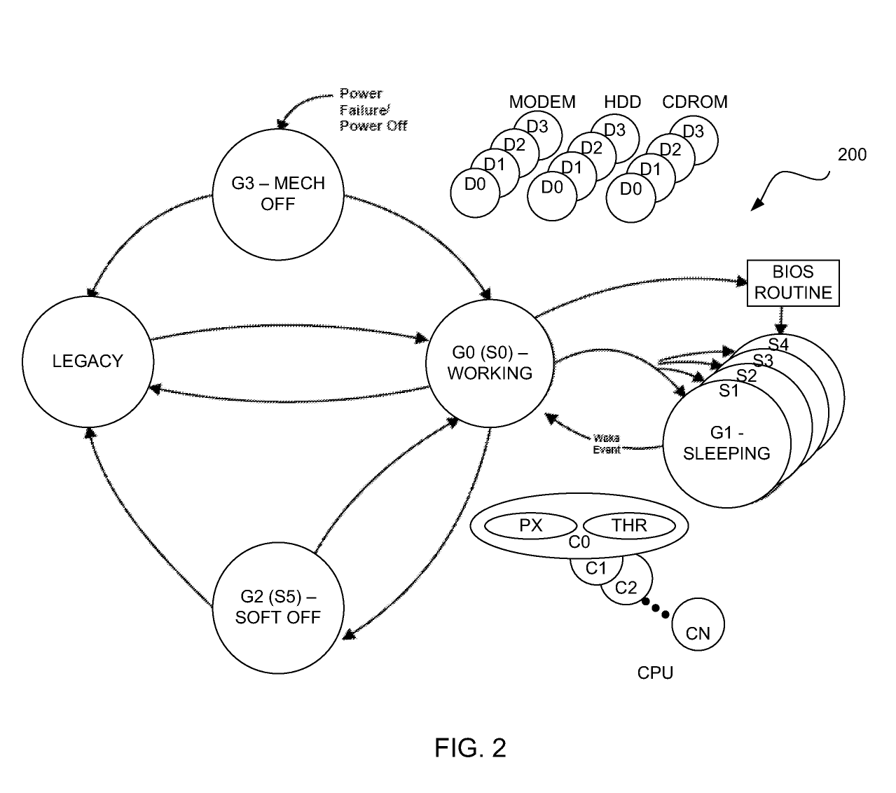

FIG. 1 is a block diagram illustrating one embodiment of an on-demand power management system utilizing software-based power management states of an electronic system 130 to detect changes in a processing demand and generate changes in energy to be delivered to the electronic system 130. The power management system 100 includes a power management controller (PMC) 110 and a power management unit (PMU) 120 that may be coupled to each other, and to other components of the electronic system 130, such as CPU 140 and one or more peripheral devices 144, via one or more communication buses 109. The one or more communication busses 109 may include a serial bus or a parallel bus. The various components illustrated in FIG. 1 may reside on different IC substrates, or on the same IC substrate. The PMU 120 provides power to the electronic system, and the PMC 110 controls the operating states of the PMU 120 in response to ACPI states 143 of the CPU 140. In one embodiment, based on the ACPI states 143 of the CPU 140, the PMC 110 may autonomously execute a power management algorithm (PMA) 114 to determine the corresponding operating states of the PMU 120. An illustration of the ACPI states 143 of the electronic system 130 may be found in FIG. 2.

In one embodiment, the PMC 110 includes an ACPI state decoder 112 that decodes the ACPI specific states 143, including the performance states (P0-Pn), device power states (D0-D3), processor power states (C0-C3), and sleeping states (S0-S5) which are sleeping within a global sleeping state G1 of global system states (G0-G1). It should be noted that although processor power states may have additional manufactured-specific states that are larger than C3. Definitions for the various different states may be found in Table 1-1 provided below at the end of the detailed description section.

The PMC 110 then dynamically adjusts the energy to be delivered (e.g., supply voltages and clock frequencies from the voltage sources 102 and clock sources 104, respectively) to the electronic system 130 via the PMU 120 without interrupting the CPU 140. In one embodiment, for example, the power management algorithm 114 may be a power management algorithm as described in U.S. Patent Publication No. 2009/0158061 may be used, the entire content of which is incorporated herein by reference. In such an embodiment, the states described therein may be replaced with the decoded ACPI states from the ACPI state decoder 112. In particular, the states described therein are based on sensed inputs from the electronic system 130, whereas the states described herein are software-based power management states that are defined in software of the electronic system 130. It should be noted that some of the embodiments described herein, however, uses the sensed inputs to determine or infer the software-defined states. Also, for a given power domain controlled by the PMU 120, the Lower Envelope Algorithm (LEA) described therein may select between different energy levels to provide to the electronic system 130 depending on the ACPI states 143 received from the CPU 140 and decoded by the ACPI state decoder 112 as described below. For example, in one embodiment, the PMC 110 can use an existing dynamic voltage scaling (DVS) of a processor core to gain knowledge of the CPU's ACPI state to user for the PMA 114. In general, the power consumption of a processor core is proportional to NCfV², where N is the number of switching gates, C is the capacitance of a gate, f is the frequency of gate switching, and V is the core voltage. Scaling the frequency based on the workload of the processor core may reduce power consumption of the processor core Likewise, the core voltage can be scaled in relation to the frequency to further reduce power. A processor core typically includes complementary metal oxide semiconductor (CMOS) circuits. Due to the nature of CMOS circuits, as the switching frequency increases, the core voltage has to be increased also to ensure proper operation. Conversely, as the switching frequency decreases, the core voltage may be decreased. Note that when the switching frequency is increased, the voltage has to be increased in advance. Likewise, when the switching frequency is decreased, the voltage has to be decreased afterwards. Thus, by using the ACPI state of the processor core, the PMA can adjust the energy to be delivered to the electronic system 130, such as the energy to be delivered to one or more peripheral devices 144.

In one embodiment, the PMC 110 monitors a processing demand in the electronic system 130 using the ACPI states 143. For example, the electronic system can be operating at a first one or more voltages and a first one or more clock frequencies phase-locked to a reference frequency in a first ACPI state. The PMC 110, based on detection of a change to the ACPI states 143, may generate a second one or more clock frequencies in response to the processing demand. The second one or more clock frequencies may be phase-locked to the reference frequency and phase-matched to the first one or more clock frequencies. The PMC 110 may also switch from the first one or more clock frequencies to the second one or more clock frequencies without halting the electronic system 130. The PMC 110, based on a change to the ACPI state 143, may also generate a second one or more voltages in response to the processing demand, and may switch from the first one or more voltages to the second one or more voltages without halting the electronic system 130.

FIG. 2 is a diagram 200 illustrating exemplary software-based power management states of the electronic system 130 as defined in the Advanced Configuration and Power Interface (ACPI) specification according to one embodiment. In one embodiment, an operating system of the CPU 140 implements an ACPI state machine 142 (illustrated in FIG. 1) to control hardware according to the these software-defined ACPI states. For example, by employing user preferences and knowledge of how devices are being used by applications, the OS puts devices in and out of low-power states. Devices that are not being used can be turned off. Similarly, the OS uses information from applications and user settings to put the system as a whole into a low-power state. The OS uses ACPI states 143 to control power state transitions in hardware. As described above, the same ACPI states 143, if brought externally from the CPU 140, may be detected by the PMC 110 to dynamically adjust the energy to be delivered (e.g., supply voltages and clock frequencies) to the electronic system 130 without interrupting the electronic system 130 (e.g., without halting the CPU 140).

The diagram 200 includes multiple Global system states (Gx states), Device power states (Dx states), Sleeping states (Sx states), Processor power states (Cx states), and Device and Processor performance states (Px states). The Global system states (Gx states) apply to the entire electronic system 130. These states may be visible to the user of the electronic system 130. Device power states (Dx states) represent the states of particular devices, such as a modem, a hard drive (HDD), and CDROM, although other states of other types of devices may be used. These state may not be visible to the user. For example, some devices may be in the Off state even though the system 130 as a whole is in the Working state. Device states apply to any device on any bus. The device power states are defined below, although very generically because, as would be appreciated by one of ordinary skill in the art having the benefit of this disclosure, the embodiments described herein may be used for various software-based power management states. It should also be noted that although the device states show four power states, in other embodiments, less than or more than four states may be used, and some of the devices may not have all of the power states defined. Devices may be capable of several different low-power modes, but if there is no user-perceptible difference between the modes, only the lowest power mode may be used, for example. Sleeping states (Sx states) are types of sleeping states within the global sleeping state, G1. Processor power states (Cx states) are processor power consumption and thermal management states within the global working state, G0. Device and Processor performance states (Px states) are power consumption and capability states within the active/executing states, C0 for processors and D0 for devices. Table 1-1 included below provides provide a brief description of the global system states, the device power states, sleeping states processor power states, and device and processor performance states.

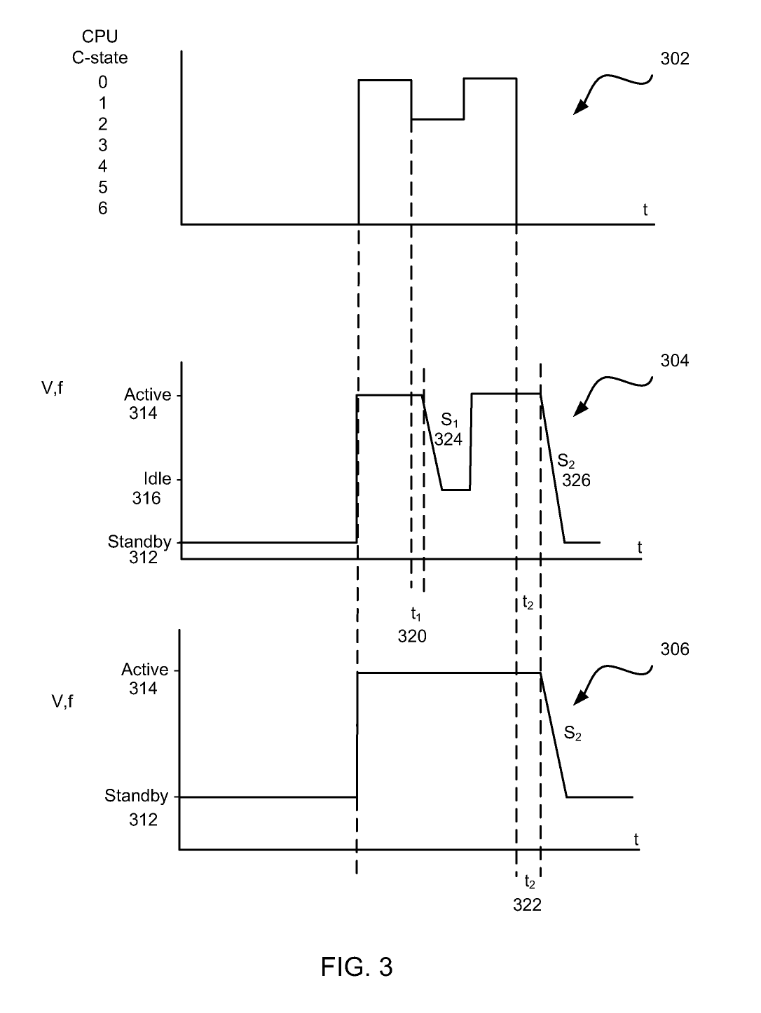

FIG. 3 are timing diagrams illustrating exemplary transitions of processor power states (C states) and corresponding exemplary changes to the energy delivered to the electronic system in response to the processor state transitions. In this exemplary embodiment, the CPU 140 starts in the C6 state, transitions to C0 state, transitions to the C2 state, transitions back to the C0 state, and then back to the C6 state, as illustrated in the diagram 302. The PMC 110 detects changes in the processing demand of the electronic system 120, by decoding the processor power states (C states) of the ACPI states 143 of the CPU 140. When the PMC 110 detects a change in the processor power states, the PMC 110 instructs the PMU 120 to change its state in order to change the energy delivered to the electronic system 130. Diagrams 304 and 306 illustrate voltage and/or frequency output signals to the electronic system 130 based on changes in the processing demands. For example, in diagram 304, the PMC 110 instructs the PMU 120 to be in a standby state 312 when the CPU 140 is in C6 state, and to transition to active state 314 when the CPU transitions to the C0 state. The PMC 110 can instruct the PMU 120 to be in an idle state 316 when the CPU 140 transitions to the C2 state. As illustrated in diagram 306, the PMC 110 can instruct the PMU 120 to be in either the active state 314 or the standby state 312, even when the CPU 140 is in the C2 state. As would be appreciated by one of ordinary skill in the art having the benefit of this disclosure, the PMC 110 can transition between two or more states in response to the changes in the processor power states (C states).

FIG. 3 also illustrates that the PMC 110 can introduce timing delays 320 and 322 between the transitions between states. This may allow for smoother transitions between operating states of the PMU, as well as avoid switching between states when the ACPI states are transitioning too quickly. The PMC 110 can also transition the voltage and/or frequency gradually, as shown by slope S1 324 and slope S2 326. For example, the slope can be used to keep monitoring circuits that monitor the power from adversely reacting to a sudden loss of power. The slope gradually reduces the power to avoid such problems.

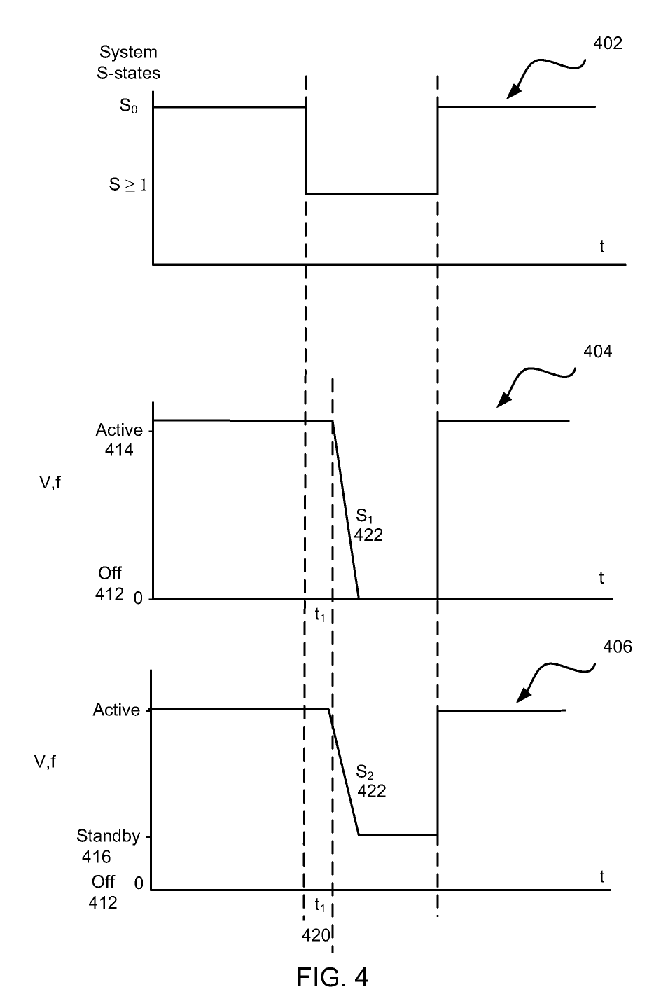

FIG. 4 are timing diagrams illustrating exemplary transitions of sleeping states (S states) and corresponding exemplary changes to the energy delivered to the electronic system 130 in response to the sleeping state transitions. In this exemplary embodiment, the electronic system 130 starts in the S0 state, transitions to some state that is equal to or greater than S1, and back to S0, as illustrated in the diagram 402. The PMC 110 detects changes in the processing demand of the electronic system 120, by decoding the system sleeping states (S states) of the ACPI states 143. When the PMC 110 detects a change in the system sleeping states, the PMC 110 instructs the PMU 120 to its state in order to change the energy delivered to the electronic system 130. Diagrams 404 and 406 illustrate voltage and/or frequency output signals to the electronic system 130 based on changes in the processing demands. For example, in diagram 404, the PMC 110 instructs the PMU 120 to be in an active state when the CPU 140 is in the S0 state, but instructs the PMU 120 to be in a “off” or “power off” state 412 (diagram 404) or in a standby state 416 (diagram 406) when the CPU 140 transitions to a state that is equal to or greater than S1. As would be appreciated by one of ordinary skill in the art having the benefit of this disclosure, the PMC 110 can transition between two or more states in response to the changes in the system sleeping states (S states). In addition, like in FIG. 3, the PMC 110 can introduce timing delays 420 between transitions and may transition using sloped transitions 422 as described above.

Alternatively, in other embodiments, the PMC 110 can monitor for changes in other types of software-based power management states, and instruct the PMU 120 to change states in order to change the energy delivered to the electronic system 130 in response to the changes in software-based power management states.

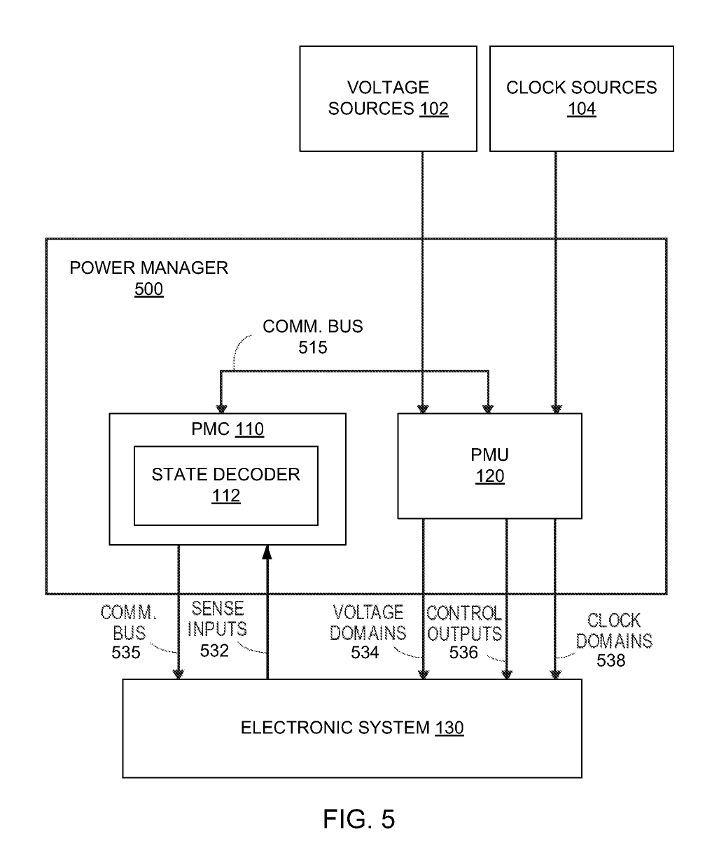

FIG. 5 is a block diagram illustrating one embodiment of a power manager 500, including the state decoder 112. The power manager 500 includes a power management controller (PMC) 110 and a power management unit (PMU) 120, coupled to each other via a communication bus 515. The PMC 110 and the PMU 120 may reside on different IC substrates, or on the same IC substrate. Alternatively, the power manager 500 may include a PMC and multiple PMUs, where some or all of the PMC and the PMUs reside on different IC substrates. The power manager 500 is coupled between voltages sources 102, clock sources 104, and the electronic system 130. Some examples of the electronic system 130 include a portable electronic system, such as a radio, a smart phone, a camera, a sensor, etc., or other non-portable electronic system, such as a desktop computer, a notebook computer, a netbook computer, a server, etc.

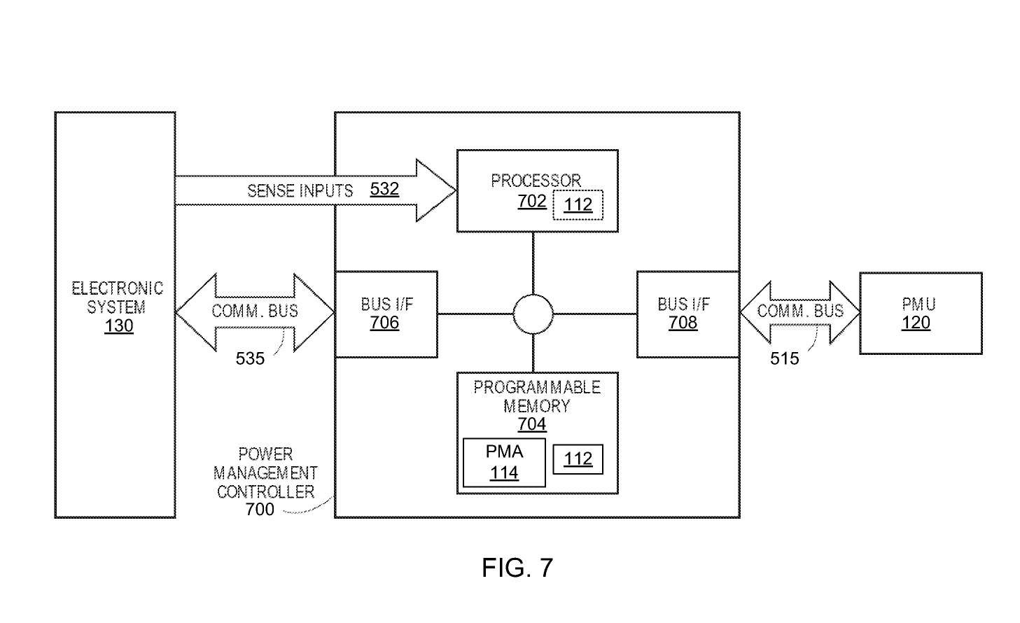

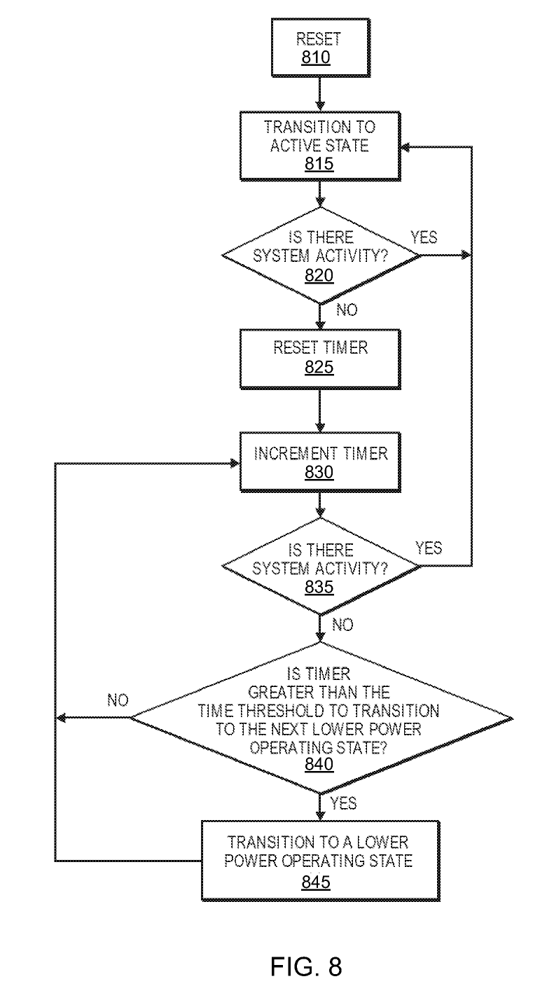

In some embodiments, the PMU 120 provides power to the electronic system 130, whereas the PMC 110 controls the operating states of the PMU 120 in response to the state decoder 112 decoding the software-based power management states of the electronic system 130. Using one or more signals received on sense inputs 532 and/or a communication bus 535, the PMC 110 may decode the particular software-based power management states to determine a processing demand of the electronic system 130. In one embodiment, based on the processing demand of the electronic system 130, the PMC 110 may autonomously execute a power management algorithm (PMA) (illustrated in FIGS. 7 and 8) to determine the corresponding operating states of the PMU 120 based on the decoded software-based power management states. An operating state of the PMU 120 may include parameters related to the voltage, frequency, and/or control outputs of the PMU 120. The PMC 110 may then control the voltage, clock, and control outputs of the PMU 120 by sending signals to the PMU 120 via the communication bus 515. The communication bus 515 may be the same communication bus that interfaces the PMC 110 to the electronic system 130. In some alternative embodiments, the PMC 110 may be interfaced to and control one or more PMUs using the same or separate communication buses.

The voltage domain outputs 534, clock domains output 2126, and control outputs 536 of the PMU 120 are adjusted by the PMU 120 to correlate with the operating states received by the PMU 120 from the PMC 110. The voltage domain outputs 534 may be used to supply voltage to one or more voltage domains in the electronic system 130. The clock domains output 538 may be used to supply a clock to one or more clock domains in the electronic system 130. The voltage domains outputs 534 and clock domains output 538 of the PMU 120 may be derived from voltage sources 102 and clock sources 104 coupled to the PMU 120, respectively. The control outputs 536 of the PMU 120 may be used to control the operating states of sub-systems and/or peripherals in the electronic system 130. For instance, one of the control outputs 536 may be a digital signal used to enable and/or disable peripherals in the electronic system 130.

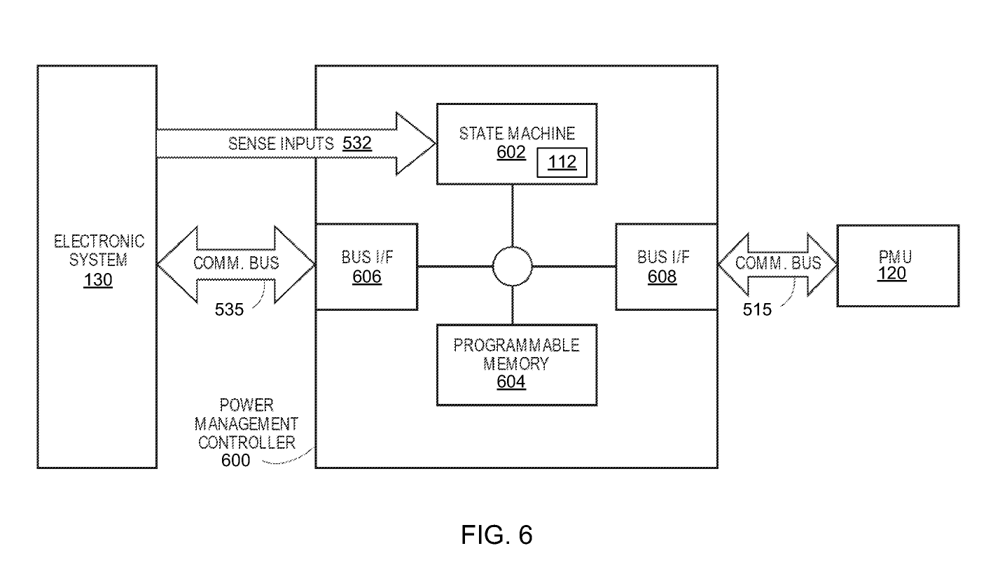

In another embodiment, the PMC 110 implements a state machine (illustrated in FIG. 6) to determine the corresponding operating states of the PMU 120 based on the decoded software-based power management states.

In one embodiment, the state decoder 112 receives an indication of the software-based power management state of the electronic system 130, such as an indication that the processor is in a particular C state, or a peripheral device is in a particular D state, for example. The processor and/or device may output a signal on a particular pin to notify other devices that it is in a particular software-based power management state. Alternatively, the processor and/or device may store the particular software-based power management state in a register to be read when requested. Alternatively, software executing on the processor and/or device may output a message periodically, or when requested, to notify other devices that it is in a particular software-based power management state. In some embodiments, the state decoder 112 can decode the signal or message directly. In other embodiments, the processor and/or devices of the electronic system 130 may not output the software-based power management states, and the state decoder 515 can determine the software-based power management state using other indications received from the electronic system 130. For example, in one embodiment, the state decoder 112 decodes the software-based power management states using one or more hardware signals received on the communication bus 535 (or via sense inputs 532) from the electronic system 130, such as one or more hardware signals measured on one or more pins on a processor of the electronic system 130. In another embodiment, the state decoder 112 decodes the software-based power management states using one or more signals indicative of the system's energy consumption or peripheral energy consumption via the sense inputs 532 (or via the communication bus 535) from the electronic system 130. In another embodiment, the state decoder 112 can logically combine multiple signals received from the electronic system 130 in order to decode the software-based power management states.

In one embodiment, the sense inputs 532 may be analog signals, digital signals, or mixed signals. In one embodiment, the state of the sense inputs 532 may be correlated to the software-based power management states of the electronic system 130. For example, the sense inputs 532 may be signals that are indicative of changes in the software-based power management states. Alternatively, the sense inputs 532 may be signals that are indicative of operating parameters of the electronic system 130 that can be used to infer the software-based power management states. In addition to receiving signals for decoding the software-based power management states, the power manager 500 may receive other sense inputs, such as, for example, chip selects, enable signals, or communication buses of peripherals in the electronic system 130. These other sense inputs 532 may also be used in connection with the state decoder 112 when determining the software-based power management state of the electronic system 130. Alternatively, the sense inputs 532 may be used to monitor the temperatures, voltages, and/or currents in the electronic system 130 for related and non-related purposes.

The state decoder 112 may be implemented in connection with a power management algorithm (PMA). In some embodiments, the PMA is implemented using hardware, such as a state machine, as illustrated in FIG. 6. In other embodiment, the PMA is implemented using software, such as the PMA stored in programmable memory illustrate in FIG. 7. In one embodiment, the PMC 110 executes PMA to determine the correct operating states of voltages, frequencies, and control signals in the electronic system 130. The PMA executed in the PMC 110 may use the state decoder 112 to determine the optimal operating states of the PMU 120. Alternatively, the state decoder 112 and/or PMA may be implemented in a combination of hardware and software.

FIG. 6 is a block diagram illustrating one embodiment of the state decoder 112 implemented in connection with a state machine 602 of a power management controller 600. The PMC 600 is coupled between the electronic system 130 and the PMU 120. The PMC 600 includes the state machine 602, a programmable memory 604, and two bus interfaces 606 and 608, which are operatively coupled to each other. In some embodiments, a PMA is implemented using hardware, such as the state machine 602. The state machine 602 receives sense inputs signals 532 from the electronic system 130 to monitor activity in the electronic system 130 and/or to determine the software-based power management state of the electronic system 130 using the state decoder 112. The state machine 602 may also receive one or more signals from the electronic system 130 via the communication bus 535 and bus interface 606. In some embodiments, the programmable memory 604 stores operating parameters.

The bus interfaces 606 and 608 communicate with the electronic system 130 and the PMU 120, respectively. Specifically, the bus interface 608 communicates with the PMU 120 over the communication bus 515. This allows the PMC 600 to control the operating states of the PMU 120. The communication bus 515 may include a serial bus or a parallel bus. The communication bus 515 may reside only on a single IC substrate that includes both the PMC 600 and the PMU 120. Alternatively, the communication bus 515 may communicatively couple two different IC substrates on which the PMC 600 and the PMU 120 reside.

In some embodiments, the bus interface 606 communicatively couples the PMC 600 with the electronic system 130 via the communication bus 535. This allows the electronic system 130 to control the operating parameters of the PMC 600, the operating states of the PMU 120, etc. The communication bus 535 may include a serial bus or a parallel bus.

The PMA that is implemented by the state machine 602 determines the operating states of the PMU 120 dynamically based on the software-based power management states in the electronic system 130 (such as the ACPI states). The software-based power management states of the electronic system 130 may be monitored through the sense inputs signals 314 and/or signals on the communication bus 535.

Each power domain controlled by the PMU 120 through voltage, clock, and/or control output changes may have multiple operating states, including active states and standby states. Furthermore, each power domain may have more than one active states, such as a fast state, a slow state, or other types of active states. In addition, each power domain may have more than one standby states, including an idle state, a power-down state, or other types of standby states.

Depending on the software-based power management states decoded by the state decoder 112, the PMA implemented by the state machine 602 may select from active or standby operating states for each power domain in the electronic system 130. For each power domain, the PMA may select from one active state and one standby state, one active state and multiple standby states, multiple active states and one standby state, multiple active and multiple standby states, or multiple active states.

One example of the PMA that may be implemented by the state machine 602 is Lower Envelope Algorithm (LEA). For a given power domain controlled by the PMU 120, the LEA selects between one active state and one or more standby states depending on the decoded software-based power management state that indicates if the power domain under control has to be in the active state. If the power domain is not in the active state, the LEA may control the PMU 120 through the bus interface 608 in the PMC 600 to transition the power domain from a non-active state to the active state with little latency. As long as the current software-based power management state identifies that the power domain under control has to be in the active state and the power domain is currently in the active state, the LEA does not transition the power domain to a standby state.

When the decoded software-based power management state no longer indicates that the power domain has to be in the active state, then the LEA may transition the power domain to a standby state after some predetermined criteria have been met. For instance, the criteria may include a time period of non-activity as determined using the decoded software-based power management state. The time delay to wait before transitioning from the active state to the standby state may be calculated based on the amount of power consumed while operating in the standby state, the amount of power consumed while transitioning from the standby state to the active state, and the time latency induced by transitioning from the standby state to the active state. Alternatively, the time delay between transitions can be programmed.

Furthermore, the LEA may transition the power domain from one standby state to another standby state based on another time period that may be calculated based on the power consumed while operating in the next standby state, the amount of power consumed while transitioning from the next standby state to the active state, and the time latency induced by transitioning from the next standby state to the active state. The length of these time periods may be stored in the programmable memory 304 in the PMC 600 and may be modified by the electronic system 130 via the communication bus 535. Alternatively, the time periods may be stored in the programmable memory 304 and can be used when transitioning from one particular software-based power management state to another.

As discussed above, the PMA may be implemented using only hardware, such as the state machine 602 in the PMC 600 in FIG. 6. Alternatively, the PMA may be implemented using machine code stored in a programmable memory and executed by a processor in the PMC. Such an embodiment is illustrated in FIG. 7.

FIG. 7 is a block diagram illustrating one embodiment of the state decoder 112 implemented in connection with the PMA 114 stored in programmable memory 704. The PMC 700 is coupled between an electronic system 130 and a PMU 120. The PMC 700 includes a processor 702, a programmable memory 704, and two bus interfaces 706 and 708, which are operatively coupled to each other. In some embodiments, the PMA 114 and/or the state decoder 112 are encoded in machine code and stored in the programmable memory 704. The processor 702 receives sense inputs signals 364 from the electronic system 130 to monitor the software-based power management states of the electronic system 130, as well as inputs received from the bus interface 706. Further, the processor 702 retrieves the PMA 114 (and/or state decoder 112) from the programmable memory 704 and executes the PMA 114 (and/or state decoder 112) in response to the software-based power management states to determine the operating state for the PMU 120.

In some embodiments, the processor 702 is a dedicated hardware controller separate from other system processor(s) that may exist in the PMC 700. For instance, the processor 702 may include one or more programmable logic devices (PLDs). While PLDs are suitable for executing the PMA, the general programmable nature of the platform may require more silicon area and more power consumption by the PMC 700. Alternatively, an application specific integrated circuit (ASIC) designed specifically for executing the PMA 114 (or a set of PMAs) may be used instead to more fully exploit the benefit of the PMA 114. Such an implementation generally results in a PMC 700 with a smaller footprint and lower power consumption.

The programmable memory 704 may include non-volatile memory (e.g., flash memory, etc.), volatile memory (e.g., dynamic random access memory (DRAM), etc.), or both. Non-volatile memory may store default operating parameters for the PMC 700 after power up of the PMC 700. In addition, the non-volatile memory may store initial operating states for the PMU 120 after power up of the PMU 120. The use of programmable non-volatile memory in the PMC 700 allows the PMU 120 to generate programmable default voltage, clock, and control outputs after power up of the PMU 120 and/or the PMC 700 independent of the sense inputs signals 314 and signals on the communication bus 535 from the electronic system 130. Furthermore, the use of programmable non-volatile memory in the PMC 700 allows the PMC 700, the electronic system 130, and/or the PMU 120 to update programmable settings and/or values in the PMC 700 during runtime of the PMC 700. As such, the PMC 700 may accept and store operating parameters that may change after power up of the electronic system 130, the PMC 700, and/or the PMU 120.

The bus interfaces 706 and 708 communicate with the electronic system 130 and the PMU 120, respectively. Specifically, the bus interface 708 communicates with the PMU 120 over the communication bus 515. This allows the PMC 700 to control the operating states of the PMU 120, as well as any other operating parameters. The communication bus 515 may include a serial bus or a parallel bus. The communication bus 515 may reside only on a single IC substrate that includes both the PMC 700 and the PMU 120. Alternatively, the communication bus 515 may communicatively couple different IC substrates on which the PMC 700 and the PMU 120 reside.

In some embodiments, the bus interface 706 allows the PMC 700 to communicate with the electronic system 130 via the communication bus 535. The communication bus 535 may include a serial bus or a parallel bus.

The PMA 114 may include a LEA, such as the exemplary embodiment illustrated in FIG. 8. Alternatively, the PMA 114 may include other power management algorithms as would be appreciated by one of ordinary skill in the art having the benefit of this disclosure.

FIG. 8 is a flow diagram illustrating one exemplary embodiment of the LEA. At block 810, the electronic system, the PMC, and the PMU are reset. Then the LEA transitions to the active state at block 815. At block 820, the LEA determines if there is any system activity. As described herein, the PMC can determine if there is any system activity by decoding the software-based power management states. If there is system activity, the LEA transitions back to block 815 to remain in the active state. Otherwise, the LEA transitions to block 825 to reset a timer. The LEA increments the timer at block 830. Then the LEA checks if there is any system activity again at block 835. As above in block 820, the PMC can decode the software-based power management states to determine the system activity. If there is system activity, the LEA returns to block 815 to remain in the active state. Otherwise, the LEA checks if the value of the timer is greater than the time threshold to transition to the next lower power operating state (such as one of the standby states) at block 840. If the value of the timer is not greater than the time threshold, then the LEA returns to block 830 to increment the timer again. Otherwise, the LEA transitions to the next lower power operating state at block 845.

In another embodiment, the PMC performs a method in which processing logic (e.g., hardware, software, or any combination thereof) receives an indication of one or more software-based power management states of the electronic system 130, and decodes the one or more software-based power management states. The processing logic generates a change in energy to be delivered to the electronic system 130 in response to the decoding. The processing logic generates the change, for example, by executing a PMA to dynamically adjust one or more voltages and/or one or more clock frequencies to be provided to the electronic system 130 in response to the decoding. In one embodiment, the indication is a hardware signal that is correlated to the one or more software-based power management states, and the processing logic decodes the software-based power management states using the hardware signal. In one embodiment, the hardware signal correlates to at least one of the G states, P states, D states, or C states as defined by the ACPI specification. For example, the current Intel platform implements Mobile Voltage Positioning 6.5, which defines two signals: 1) the DPRSLPVR signal that indicates that the processor is in a deeper sleep state (deeper than a normal state); and 2) the PSI# indicates that the processor is in a low current state (lower than a normal state). By monitoring one or both of these signals, processing logic can see when the processor is an active or idle ACPI state. In some cases, the processing logic can monitor status signals from the peripherals with the assumption that when the peripheral status changes, there must be a corresponding change in ACPI state. In another embodiment, the processing logic could decode CPU core regulator Voltage ID (VID) codes, since the VID codes could be correlated to the processing power states (C states). Alternatively, the hardware signal may correlate to other types of software-based power management states.

In another embodiment, the processing logic receives multiple hardware signals, such as both the PSI# and DPRSLPVR signals, as the indication, and logically combines the two signals to decode the software-based power management states. In this case, the logical combination of the multiple hardware signals correlates to the one or more software-based power management states, such as the ACPI states.

In another embodiment, the processing logic receives one or more signals indicative of system energy consumption, or indicative of peripheral energy consumption. The system or peripheral energy consumption indicates the system activity or peripheral activity. By monitoring changes in the peripheral energy consumption, processing logic can estimate when the system (or peripheral) is in an active or idle ACPI state. In one embodiment, the processing logic can use a threshold, and if the activity is above the threshold, the processing logic determines that the ACPI state is active, and if the activity is below the threshold, the processing logic determines that the ACPI states is inactive. In other embodiments, the processing logic may use multiple thresholds. In more complex systems, the processing logic can calculate the rate of change of the energy consumption, as well as the amplitude of the change, to isolate different activity types, allows the processing logic to more precisely identify the ACPI state. Alternatively, the processing logic can estimate the ACPI state using other methods as would be appreciated by one of ordinary skill in the art having the benefit of this disclosure. In these embodiments, the system or peripheral energy consumption correlates to the one or more software-based power management states.

In one embodiment, the electronic system 130 includes the processor and one or more peripherals, such as a HDD or an ODD. The processing logic measures the current for HDD or ODD activity for the peripheral energy consumption, and based on changes to the peripheral energy consumption, the processing logic determines the appropriate ACPI state. In another embodiment, the processing logic measures a combined Universal Serial Bus (USB) device current at a point on the electronic system (e.g., at a point on the motherboard). The processing logic filters the signal at one or more cutoff frequencies (e.g., using one or more low pass filters). The processing logic can substract the different filtered signals to get corresponding activity signals that are proportional to the rate of change and magnitude of the device current demand. The rate of change and magnitude of the current demand can be correlated to the one or more software-bases power management states. Alternatively, this method of measuring energy consumption may be used for other peripheral devices than USB devices. For example, the processing logic can measure the supply current being provided to any peripheral device, and can determine the ACPI state based on this measurement.

In another embodiment, the processing logic receives one or more signals indicative of system (or peripheral) energy consumption, as well as one or more hardware signals as described above. The processing logic logically combines the hardware signals and the energy consumption signals (e.g., consumption measurements) for decoding the software-based power management states.

In another embodiment, the processing logic detects changes in the one or more software-based power management states that correspond to changes in a processing demand of the electronic system, and generates changes in energy to be delivered to the electronic system based on the changes in the processing demand.

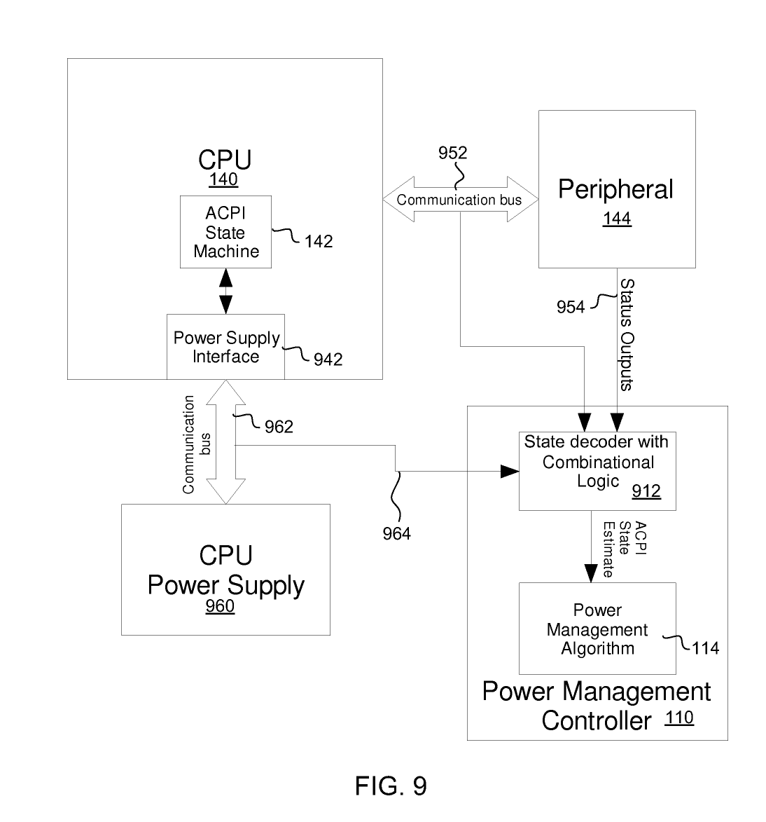

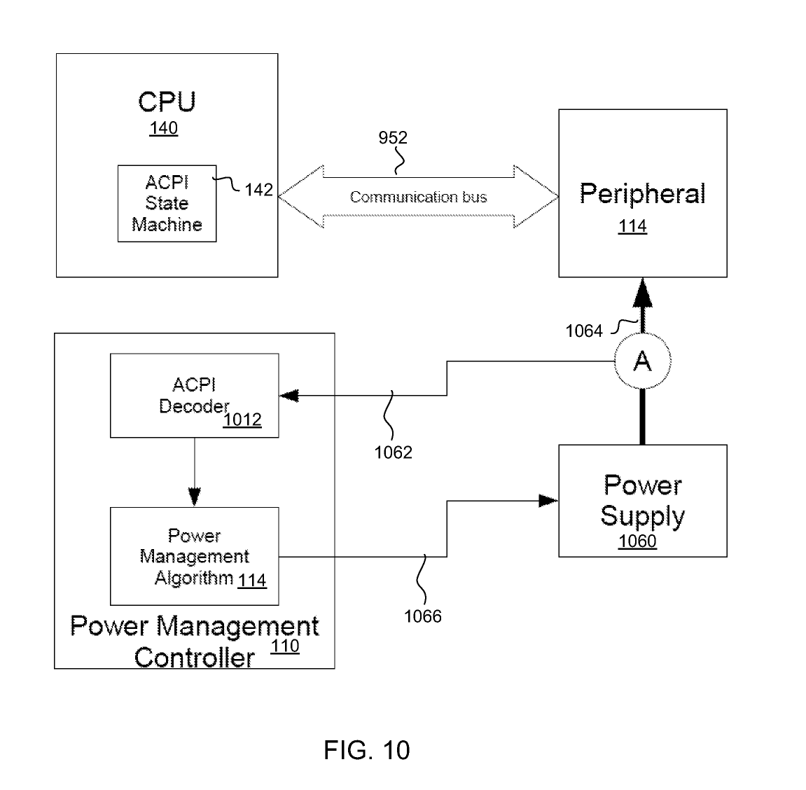

As described herein, in some embodiments, the software-based power management state (e.g., ACPI state) of a processor is held in software, and thus, may be directly observable outside of the processor on some current hardware platforms. Thus, the software-based power management states may need to be estimated, or otherwise inferred from other indications of the state, as described herein. FIGS. 9 and 10 illustrate two mechanisms that can be used to estimate the ACPI states externally from the CPU 140 using one or more indications of the ACPI states. These depicted embodiments assume that peripheral activity occurs with CPU activity when the CPU is in an active ACPI state. Alternatively, some hardware platforms may allow the software-based power management states to be directly observable outside of the processor, such as for the benefit of other devices in the electronic system 130 (e.g., the chipset), or in these embodiments, to facilitate an external power management scheme of devices in the electronic system 130. For example, manufacturers of processors and/or chipsets could implement a mechanism to allow transparency of the software-based power management states on some hardware platforms. In one embodiment, the processor produces a hardware signal, such as on a dedicated pin or pins that indicates the ACPI state. In another embodiment, the operating system or the embedded controller (e.g., BIOS) could store the ACPI state in a register that can be read in response to a request for the ACPI state. Alternatively, the processor could output the ACPI state using other mechanisms as would be appreciated by one of ordinary skill in the art having the benefit of this disclosure.

FIG. 9 is a block diagram illustrating one embodiment of the PMC 110 having a state decoder 912 with combinational logic to decode software-based power management states of a processor of the electronic system 130. In this embodiment, the CPU 140 and its core power supply 960 have a signal that is indicative of, or at least strongly correlated to certain ACPI C states. For example, the current Intel platform implements Mobile Voltage Positioning 6.5 defines two such signals: DPRSLPVR indicates that the processor is in deeper sleep mode and PSI# indicates that the processor is in a low current state. By monitoring one or both of these signals on the communication bus 962, the state decoder 912 can determine when the CPU 140 is in an active or idle ACPI state. In other embodiments, the state decoder 912 can use combinational logic to logically combine multiple signals being monitored on the communication bus 962 to decode the ACPI states of the CPU 140. In other embodiments, the state decoder 912 can monitors one or more signals on the communication bus 952 between the CPU 140 and the one or more peripheral devices 144. In other embodiments, the state decoder 912 can monitor status signals 954 received from one or more peripheral devices 144 with the assumption that when the peripheral status changes, there must be a corresponding change in ACPI state.

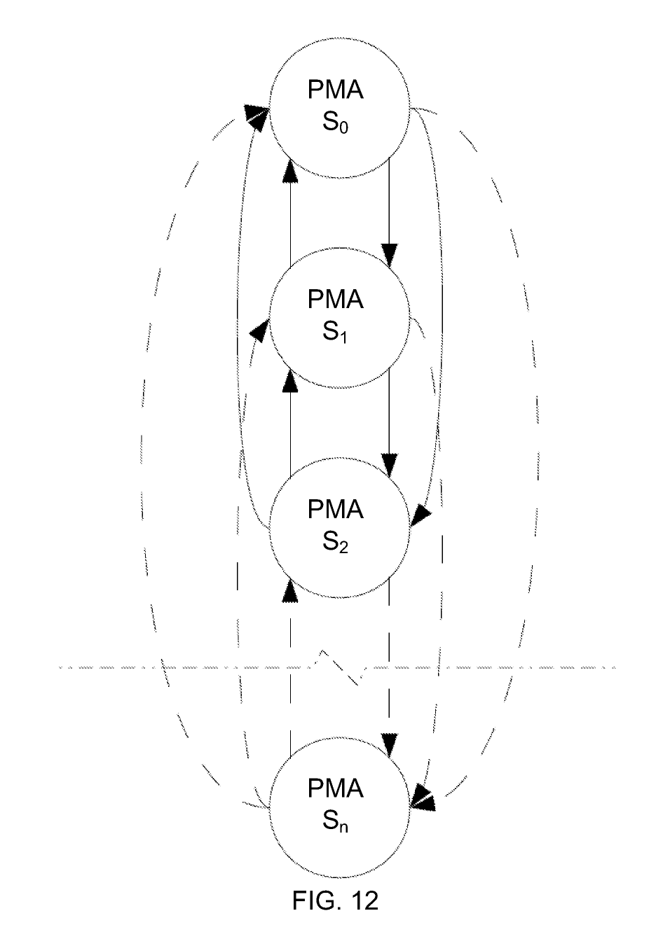

Based on the input to the state decoder 912, the state decoder 912 outputs an ACPI state estimate to the PMA 114 to change the operating state of the PMU 120. In the case of the PMA being implemented in hardware, the decoded ACPI states can be directly mapped to the PMA states in the hardware state machine, such as illustrated in FIG. 12. Alternatively, the mapping between the software-based power management states of the electronic system 130 and the operating states of the PMU 120 may be done in a software-like manner, such as using a table, also described with respect to FIG. 12.

FIG. 10 is a block diagram illustrating another embodiment of the power PMC 110 having an ACPI state decoder 1012 and the PMA 114. The ACPI state decoder 1012 is coupled to receive a signal 1062 indicative of peripheral energy consumption of one or more peripheral devices 114 of the electronic system 130. The signal 1062, as depicted in FIG. 10, is a signal that indicates the (or system) energy consumption. By monitoring changes in the peripheral (or system) energy consumption, the ACPI state decoder 1012 can estimate when the electronic system is in an active or idle ACPI state. In the simplest form, the ACPI state decoder 1012 uses a threshold. When the signal 1062 is above the threshold, the ACPI state decoder 1012 determines that the ACPI state is active, and when below the threshold, the ACPI state is inactive. In other embodiments, the state decoder 1012 uses multiple thresholds. Alternatively, the ACPI state decoder 1012 can calculate the rate of change of the energy consumption, amplitude of the change, or the like to isolate different activity types. This allows the ACPI state decoder 1012 to precisely identify the ACPI state. Alternatively, the ACPI state decoder 1012 can estimate the ACPI state using other techniques as would be appreciated by one of ordinary skill in the art having the benefit of this disclosure.

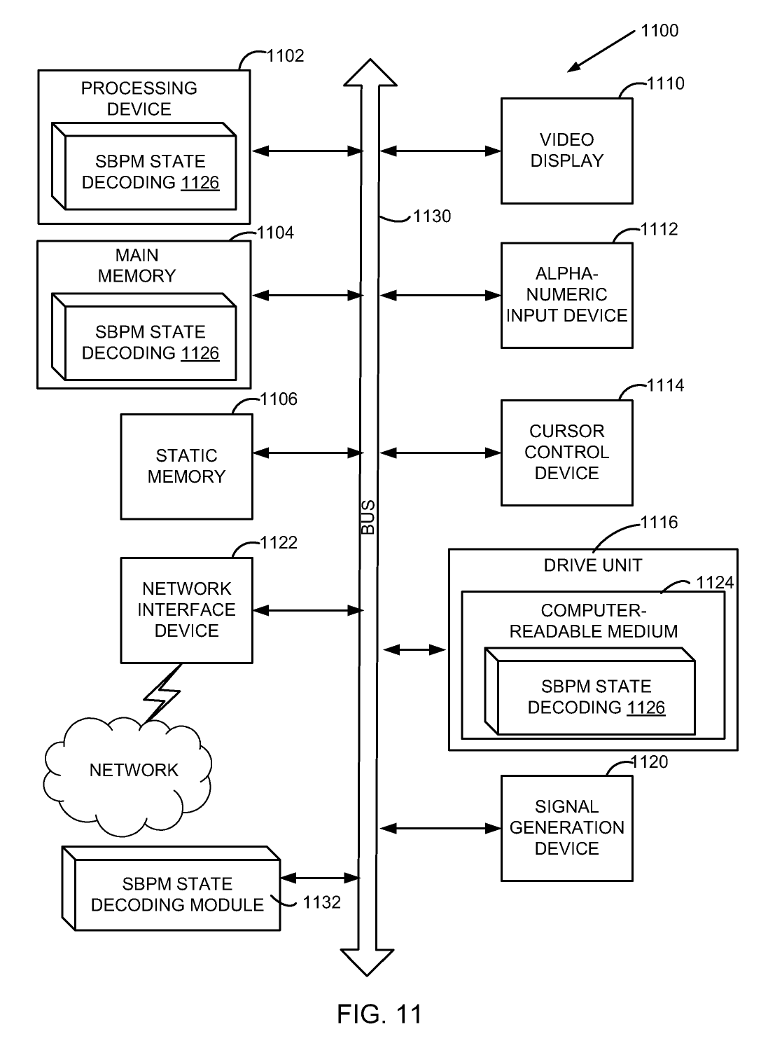

FIG. 11 illustrates a diagrammatic representation of a machine in the exemplary form of a computing system for software-based power management state decoding. Within the computing system 1100 is a set of instructions for causing the machine to perform any one or more of the methodologies discussed herein. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a PC, a tablet PC, a set-top-box (STB), a personal data assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein for decoding software-based power management states, such as the methods described above. In one embodiment, the computing system 1100 represents various components that may be implemented in the power management controller (PMC) 110 of FIGS. 1, 9, and 10, the power manager 500 of FIG. 5, and the power management controllers 600 and 700 of FIGS. 6 and 7. Alternatively, these devices may include more or less components as illustrated in the computing system 1100.

The exemplary computing system 1100 includes a processing device 1102, a main memory 1104 (e.g., read-only memory (ROM), flash memory, dynamic random access memory (DRAM) such as synchronous DRAM (SDRAM), etc.), a static memory 1106 (e.g., flash memory, static random access memory (SRAM), etc.), and a data storage device 1116, each of which communicate with each other via a bus 1130.

Processing device 1102 represents one or more general-purpose processing devices such as a microprocessor, central processing unit, or the like. More particularly, the processing device 1102 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1102 may also be one or more special-purpose processing devices such as an application specific integrated circuit (ASIC), a field programmable gate array (FPGA), a digital signal processor (DSP), network processor, or the like. The processing device 1102 is configured to execute the processing logic (e.g., software-based power management state decoding 1126) for performing the operations and steps discussed herein.

The computing system 1100 may further include a network interface device 1122. The computing system 1100 also may include a video display unit 1110 (e.g., a liquid crystal display (LCD) or a cathode ray tube (CRT)), an alphanumeric input device 1112 (e.g., a keyboard), a cursor control device 1114 (e.g., a mouse), and a signal generation device 1120 (e.g., a speaker).

The data storage device 1116 may include a computer-readable storage medium 1124 on which is stored one or more sets of instructions (e.g., software-based power management state decoding 1126) embodying any one or more of the methodologies or functions described herein. The software-based power management state decoding 1126 may also reside, completely or at least partially, within the main memory 1104 and/or within the processing device 1102 during execution thereof by the computing system 1100, the main memory 1104 and the processing device 1102 also constituting computer-readable storage media. The software-based power management state decoding 1126 may further be transmitted or received over a network via the network interface device 1122.

While the computer-readable storage medium 1124 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, or other types of mediums for storing the instructions. The term “computer-readable transmission medium” shall be taken to include any medium that is capable of transmitting a set of instructions for execution by the machine to cause the machine to perform any one or more of the methodologies of the present embodiments.

The software-based power management states decoding module 1132, components, and other features described herein (for example in relation to FIGS. 1, 5-7, and 9-10) can be implemented as discrete hardware components or integrated in the functionality of hardware components such as ASICS, FPGAs, DSPs, or similar devices. The software-based power management states decoding module 1132 may implement operations of a method as described herein with respect to FIG. 8. In addition, the software-based power management states decoding module 1132 can be implemented as firmware or functional circuitry within hardware devices. Further, the software-based power management states decoding module 1132 can be implemented in any combination hardware devices and software components.

FIG. 12 illustrates a generalized PMA having multiple operating states mapped to corresponding software-based power management states. In some embodiments, the mappings could be done in hardware where the mapping would be part of the state machine configuration (direct mapping). For example, the PMA state S0 could map to ACPI state C0, PMA state S1 could map to ACPI state C3, and so on. This would be similar to the CPU C-state waveform drawings of FIG. 3. A variant of this is to use the ACPI states to define which transitions are taken between the PMA states. In the drawing with four PMA states (PMA Sn being the fourth), there are three ways to exit or enter any given state. The LEA algorithm, described and illustrated with respect to FIG. 8, defines one subset of these, but other configurations could be used and they could be dependent on the ACPI state. For example, the PMA could jump from PMA S2 directly to PMA S0, but only if in ACPI C-state C0.

In other embodiments, the mapping between the software-based power management states of the electronic system 130 and the operating states of the PMU 120 may be done in a software-like manner, such as using a table. In these embodiments, the table could have, for each ACPI state, the voltage, frequency, and timeout values for each of the PMA states. Upon detecting a change in ACPI state, the corresponding table entry would be loaded into the PMA state machine. This wouldn't necessarily have to take place in software, it could be done with table lookups in hardware or by using the decoded ACPI state as an index to a multiplexer to select different values for the PMA.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to utilize the invention and various embodiments with various modifications as may be suited to the particular use contemplated.

TABLE 1-1

| | |
|---|---|
| G3 | A computer state that is entered and left by a |
| Mechanical | mechanical means (for example, turning off the |
| Off | system's power through the movement of a large |
| | red switch). Various government agencies and |
| | countries require this operating mode. It is implied |
| | by the entry of this off state through a mechanical |
| | means that no electrical current is running through |
| | the circuitry and that it can be worked on without |
| | damaging the hardware or endangering service |
| | personnel. The OS must be restarted to return to the |
| | Working state. No hardware context is retained. |
| | Except for the real-time clock, power consumption |
| | is zero. |
| G2/S5 | A computer state where the computer consumes |
| Soft Off | a minimal amount of power. No user mode or |
| | system mode code is run. This state requires a large |
| | latency in order to return to the Working state. The |
| | system's context will not be preserved by the |
| | hardware. The system must be restarted to return |
| | to the Working state. It is not safe to disassemble |
| | the machine in this state. |
| G1 Sleeping | A computer state where the computer consumes a |
| | small amount of power, user mode threads are not |
| | being executed, and the system “appears” to be off |
| | (from an end user's perspective, the display is off, |
| | and so on). Latency for returning to the Working |
| | state varies on the wake environment selected prior |
| | to entry of this state (for example, whether the system |
| | should answer phone calls). Work can be resumed |
| | without rebooting the OS because large elements of |
| | system context are saved by the hardware and the |
| | rest by system software. It is not safe to disassemble |
| | the machine in this state. |
| G0 Working | A computer state where the system dispatches user |
| | mode (application) threads and they execute. In this |
| | state, peripheral devices (peripherals) are having |
| | their power state changed dynamically. The user |
| | can select, through some UI, various performance/ |
| | power characteristics of the system to have the |
| | software optimize for performance or battery life. |
| | The system responds to external events in real time. |
| | It is not safe to disassemble the machine in this state. |
| S4 Non- | A special global system state that allows system |
| Volatile | context to be saved and restored (relatively slowly) |
| Sleep | when power is lost to the motherboard. If the system |
| | has been commanded to enter S4, the OS will write |
| | all system context to a file on non-volatile storage |
| | media and leave appropriate context markers. The |
| | machine will then enter the S4 state. When the |
| | system leaves the Soft Off or Mechanical Off state, |
| | transitioning to Working (G0) and restarting the OS, |
| | a restore from a NVS file can occur. This will only |
| | happen if a valid non-volatile sleep data set is found, |
| | certain aspects of the configuration of the machine |
| | have not changed, and the user has not manually |
| | aborted the restore. If all these conditions are met, |
| | as part of the OS restarting, it will reload the system |
| | context and activate it. The net effect for the user is |
| | what looks like a resume from a Sleeping (G1) state |
| | (albeit slower). The aspects of the machine config- |
| | uration that must not change include, but are not |
| | limited to, disk layout and memory size. It might |
| | be possible for the user to swap a PC Card or a |
| | Device Bay device, however. |
| D3 (Off) | Power has been fully removed from the device. |
| | The device context is lost when this state is entered, |
| | so the OS software will reinitialize the device when |
| | powering it back on. Since device context and |
| | power are lost, devices in this state do not decode |
| | their address lines. Devices in this state have the |
| | longest restore times. All classes of devices define |
| | this state. |
| D3hot | The meaning of the D3hot State is defined by |
| | each device class. Devices in the D3hot State are |
| | required to be software enumerable. In general, |
| | D3hot is expected to save more power and |
| | optionally preserve device context. If device |
| | context is lost when this state is entered, the OS |
| | software will reinitialize the device when |
| | transitioning to D0. Devices in this state can |
| | have long restore times. All classes of devices |
| | define this state. |
| D2 | The meaning of the D2 Device State is defined |
| | by each device class. Many device classes may |
| | not define D2. In general, D2 is expected to save |
| | more power and preserve less device context |
| | than D1 or D0. Buses in D2 may cause the device |
| | to lose some context (for example, by reducing |
| | power on the bus, thus forcing the device to turn |
| | off some of its functions). |
| D1 | The meaning of the D1 Device State is defined by |
| | each device class. Many device classes may not |
| | define D1. In general, D1 is expected to save less |
| | power and preserve more device context than D2. |
| D0 | This state is assumed to be the highest level of power |
| (Fully-On) | consumption. The device is completely active and |
| | responsive, and is expected to remember all relevant |
| | context continuously. |
| S1 | The S1 sleeping state is a low wake latency |
| Sleeping | sleeping state. In this state, no system context is |
| State | lost (CPU or chip set) and hardware maintains all |
| | system context. |
| S2 | The S2 sleeping state is a low wake latency sleeping |
| Sleeping | state. This state is similar to the S1 sleeping state |
| State | except that the CPU and system cache context is |
| | lost (the OS is responsible for maintaining the caches |
| | and CPU context). Control starts from the processor's |
| | reset vector after the wake event. |
| S3 | The S3 sleeping state is a low wake latency sleeping |
| Sleeping | state where all system context is lost except system |
| State | memory. CPU, cache, and chip set context are lost |
| | in this state. Hardware maintains memory context |
| | and restores some CPU and L2 configuration context. |
| | Control starts from the processor's reset vector after |
| | the wake event. |
| S4 | The S4 sleeping state is the lowest power, longest |
| Sleeping | wake latency sleeping state supported by ACPI. In |
| State | order to reduce power to a minimum, it is assumed |
| | that the hardware platform has powered off all devices. |
| | Platform context is maintained. |
| S5 Soft | The S5 state is similar to the S4 state except that the |
| Off State | OS does not save any context. The system is in the |
| | “soft” off state and requires a complete boot when |
| | it wakes. Software uses a different state value to |
| | distinguish between the S5 state and the S4 state to |
| | allow for initial boot operations within the BIOS to |
| | distinguish whether or not the boot is going to wake |
| | from a saved memory image. |
| C0 Processor | While the processor is in this state, it executes |
| Power State | instructions. |
| C1 Processor | This processor power state has the lowest latency. |
| Power State | The hardware latency in this state must be low enough |
| | that the operating software does not consider the |
| | latency aspect of the state when deciding whether to |
| | use it. Aside from putting the processor in a non- |
| | executing power state, this state has no other software- |
| | visible effects. |
| C2 Processor | The C2 state offers improved power savings over |
| Power State | the C1 state. The worst-case hardware latency for |
| | this state is provided via the ACPI system firmware |
| | and the operating software can use this information |
| | to determine when the C1 state should be used instead |
| | of the C2 state. Aside from putting the processor in a |
| | non-executing power state, this state has no other |
| | software-visible effects. |
| C3 Processor | The C3 state offers improved power savings over the |
| Power State | C1 and C2 states. The worst-case hardware latency for |
| | this state is provided via the ACPI system firmware and |
| | the operating software can use this information to |
| | determine when the C2 state should be used instead of |
| | the C3 state. While in the C3 state, the processor's |
| | caches maintain state but ignore any snoops. The |
| | operating software is responsible for ensuring that the |
| | caches maintain coherency. |
| P0 Perfor- | While a device or processor is in this state, it uses its |
| mance State | maximum performance capability and may consume |
| | maximum power. |
| P1 Perfor- | In this performance power state, the performance |
| mance State | capability of a device or processor is limited below |
| | its maximum and consumes less than maximum |
| | power. |
| Pn Perfor- | In this performance state, the performance capability |
| mance State | of a device or processor is at its minimum level and |
| | consumes minimal power while remaining in an |
| | active state. State n is a maximum number and is |
| | processor or device dependent. Processors and |
| | devices may define support for an arbitrary number of |
| | performance states not to exceed 16. |

1. A method, comprising:
receiving, at a power management controller, an indication of one or more software-based power management states of an electronic system;
decoding the one or more software-based power management states by the power management controller; and
generating a change in energy to be delivered to the electronic system in response to the decoding of the one or more software-based power management states.

2. The method of claim 1, wherein said receiving the indication comprises receiving a hardware signal that is correlated to the one or more software-based power management states, and wherein said decoding comprises decoding the one or more software-based power management states using the hardware signal.

3. The method of claim 2, wherein the hardware signal correlates to at least one of global system states (G states), performances states (P states), device states (D states), or processor power states (C states) as defined by the Advanced Configuration and Power Interface (ACPI) standard.

4. The method of claim 3, wherein the electronic system comprises a processor, wherein the hardware signal is a signal that indicates that the processor is in a lower current state than a normal state, and wherein the signal correlates to the processor power states (C states) of the processor.

5. The method of claim 3, wherein the electronic system comprises a processor, wherein the hardware signal is a signal of the processor that indicates that the processor is in a deeper sleep state than a normal state, and wherein the signal correlates to the processor power states (C states) of the processor.

6. The method of claim 5, wherein said receiving the indication comprises receiving a processor core regulator voltage identifier (VID) code from the processor, wherein said decoding comprises decoding the processor core regulator VID code, and wherein the processor core regulator VID code correlates to the processor power states (C states).

7. The method of claim 1, wherein said receiving the indication comprises receiving a plurality of hardware signals, and wherein said decoding comprises logically combining the plurality of hardware signals to decode the one or more software-based power management states, wherein the logical combination of the plurality of hardware signals is correlated to the one or more software-based power management states.

8. The method of claim 6, wherein the logical combination of the plurality of hardware signals correlates to at least one of global system states (G states), performances states (P states), device states (D states), or processor power states (C states) as defined by the Advanced Configuration and Power Interface (ACPI) standard.

9. The method of claim 7, wherein the electronic system comprises a processor, wherein the plurality of hardware signals comprises a first signal that indicates that the processor is in a lower current state than a normal state and a second signal that indicates that the processor is in a deeper sleep state than the normal state, and wherein the logical combination of the first and second signals correlates to the processor power states (C states) of the processor.

10. The method of claim 1, wherein said receiving the indication comprises receiving one or more signals indicative of system energy consumption of the electronic system, wherein said decoding comprises measuring changes in the system energy consumption to decode the one or more software-based power management states, and wherein the system energy consumption is correlated to the one or more software-based power management states.

11. The method of claim 1, wherein the electronic system comprises a processor and one or more peripheral devices, wherein said receiving the indication comprises receiving one or more signals indicative of peripheral energy consumption of the one or more peripheral devices, wherein said decoding comprises measuring changes in the peripheral energy consumption to decode the one or more software-based power management states, and wherein the peripheral energy consumption is correlated to the one or more software-based power management states.

12. The method of claim 11, wherein the one or more peripheral devices comprise a Universal Serial Bus (USB) device, wherein the one or more signals indicative of peripheral energy consumption is a measured current signal, and wherein said decoding comprises:
filtering the measured current signal at a plurality of cutoff frequencies; and
subtracting the filtered signals to get a plurality of activity signals that are proportional to a rate of change and magnitude of a current demand of the USB device, wherein the rate of change and magnitude of the current demand are correlated to the one or more software-bases power management states.

13. The method of claim 1, wherein said receiving the indication comprises receiving one or more energy consumption signals indicative of system energy consumption of the electronic system and one or more hardware signals from a processor of the electronic system, wherein said decoding comprises logically combining the one or more energy consumption signals and the hardware signals to decode the one or more software-based power management states, and wherein the logical combination of the one or more energy consumption signals and the hardware signals is correlated to the one or more software-based power management states.

14. The method of claim 1, wherein said generating the change comprises executing a power management algorithm by the power management controller to dynamically adjusting one or more of supply voltages and clock frequencies to be provided to the electronic system in response to the said decoding.

15. The method of claim 1, wherein said generating the change comprises:
detecting changes in the one or more software-based power management states, wherein the changes in the one or more software-based power management states correspond to changes in a processing demand; and
generating changes in energy to be delivered to the electronic system based on the changes in the processing demand.

16. A power manager system, comprising:
a power management controller (PMC) configured to receive an indication of one or more software-based power management states of an electronic system; and
a power management unit (PMU) coupled to the PMC, wherein the PMU is configured to provide power to the electronic system, and wherein the PMC is configured to decode the one or more software-based power management states and to instruct the PMU to adjust the power provided to the electronic system in response to the decoding.

17. The apparatus of claim 16, wherein the PMC comprises:
a state machine to implement a power management algorithm (PMA) and to receive the indication of the one or more software-based power management states as one or more inputs;
a programmable memory coupled to the state machine to store operating parameters of an operating state of the PMU, wherein the operating parameters comprise at least one of a voltage, a frequency, or a control signal;
a first bus interface coupled to the state machine, to communicate with the electronic system; and
a second bus interface coupled to the state machine, to communicate with the PMU.

18. The apparatus of claim 17, wherein the PMA comprises a Lower Envelope Algorithm.

19. The apparatus of claim 16, wherein the PMC comprises:
a programmable memory to store operating parameters of an operating state of the PMU and instructions of a power management algorithm (PMA), wherein the operating parameters comprise at least one of a voltage, a frequency, or a control signal;
a processor coupled to the programmable memory, to execute the instructions of the PMA and to receive the indication of the one or more software-based power management states as one or more inputs;
a first bus interface coupled to the processor, to communicate with the electronic system; and
a second bus interface coupled to the processor, to communicate with the PMU.

20. The apparatus of claim 19, wherein the PMA comprises a lower envelope algorithm.

21. The apparatus of claim 16, wherein the PMU is configured to control at least one power domain of the electronic system, the at least one power domain comprising a plurality of power states, and wherein the PMC is configured to select one of the plurality of power states based on the PMC decoding the one or more software-based power management states according to the PMA and is configured to cause the PMU to enter into the selected one of the plurality of power states.

22. A system comprising the apparatus of claim 16, further comprising:
the electronic system comprising a processor and one or more peripheral devices, and wherein the processor implements a state machine that changes power management states of the electronic system using the one or more software-based power management states, wherein the one or more software-based power management states are defined in the Advanced Configuration and Power Interface (ACPI) standard; and
a communication bus coupled between the electronic system and the PMC.

23. A machine-readable storage medium that provides instructions that, when executed by a power management controller (PMC), causes the PMC to perform the method of claim 1.
